(19) United States
(12) Patent Application Publication
(10) Pub. No.: US 2022/0090306 A1
(43) Pub. Date: Mar. 24, 2022

(54) EMBROIDERED LEATHER PATCHES

(71) Applicant: Brianna Paige Lester, Reidsville, NC (US)

(72) Inventor: Brianna Paige Lester, Reidsville, NC (US)

(21) Appl. No.: 17/448,275

(22) Filed: Sep. 21, 2021

Related U.S. Application Data
(60) Provisional application No. 62/706,956, filed on Sep. 21, 2020.

(51) Int. Cl. D05C 17/00; B32B 3/26; B32B 9/02; B32B 9/04; B32B 37/06; B32B 37/10; B32B 37/18; B32B 38/00; A44B 15/00

(52) U.S. Cl. CPC D05C 17/00; B32B 2556/00; B32B 9/025; B32B 9/04; B32B 37/06; B32B 37/10; B32B 37/18; B32B 38/0004; B32B 38/0008; A44B 15/00; B32B 2309/02; B32B 2309/04; B32B 2307/31; B32B 2317/08; B32B 2451/00; B32B 2305/10; B32B 2307/404; B32B 3/263

(57) ABSTRACT

A multi-color embroidered leather article includes a leather substrate having a finish surface and a reverse surface and embroidery floss embroidered onto the finish surface. The multi-color leather article is prepared by an embroidery method. The method includes placing the leather substrate on a backing, with the reverse surface in direct contact with the backing; assembling an embroidery hoop on the leather substrate and the backing; embroidering the leather substrate and the backing; removing the embroidery hoop; removing the backing; and clipping excess embroidery floss from the reverse surface.

### CROSS-REFERENCE TO RELATED APPLICATION

This application claims the benefit of priority of U.S. provisional application No. 62/706,956, filed Sep. 21, 2020, the contents of which are herein incorporated by reference.

### BACKGROUND OF THE INVENTION

The present invention relates to leather patches and, more particularly, to embroidered leather patches.

Leather is a desirable decorative medium to display logos and other graphics, for example for promotional purposes on headwear and other apparel. Currently, the only available techniques for applying graphics to leather are tool, laser, or paint. These techniques are costly for both the producer and the consumer and are unable to produce detailed, full color graphics. Painting and tooling are labor-intensive and require more production time and thicker leather than lasering, causing the outcome to be bulky and expensive. Lasering only provides one color, limiting the graphics that can be applied.

As can be seen, there is a need for an inexpensive method of applying multicolor graphics to leather quickly, without extensive labor.

### SUMMARY OF THE INVENTION

The present invention provides embroidered leather and a method of production thereof. Embroidered leather is very useful for clothing, headwear, or any object of fabric that can be used in a heat press. Embroidered leather may also be used to display graphics or logos on upholstery, including upholstery for the automobile and aircraft industry. Embroidered leather may also be used for purses, handbags, travel bags, and certain horse wear items, including saddle pads and halters. Moreover, heat seal is a quicker, more efficient, and less costly means of attachment than sewing a patch onto another article.

In one aspect of the present invention, a multi-color embroidered leather article is provided, comprising a leather substrate having a finish surface and a reverse surface and embroidery floss embroidered onto the finish surface.

In another aspect of the present invention, a multi-color leather embroidery method is provided, comprising: placing a leather substrate having a finish surface and a reverse surface on a backing, with the reverse surface in direct contact with the backing; assembling an embroidery hoop on the leather substrate and the backing; embroidering the leather substrate and the backing; removing the embroidery hoop; removing the backing; and clipping excess embroidery floss from the reverse surface to produce an embroidered leather substrate.

These and other features, aspects and advantages of the present invention will become better understood with reference to the following drawings, description, and claims.

### BRIEF DESCRIPTION OF THE DRAWINGS

FIG. 1 is a flowchart of a method of preparing an embroidered leatherwork patch according to an embodiment of the present invention;

FIG. 2A is a top plan view of a logo for reproduction according to the method;

FIG. 2B is a top plan view of a leather base material therefor;

FIG. 3 is a schematic view illustrating the method of FIG. 1;

FIG. 4 is a top plan view of the leather base material of FIG. 2B in an embroidery hoop therefor;

FIG. 5 is a top perspective view of an embroidery step thereof;

FIG. 6 is a top plan view showing an intermediate product thereof retained within the embroidery hoop;

FIG. 7 is a top plan view of the intermediate product removed from the embroidery hoop;

FIG. 8 is a bottom plan view thereof, showing a step of preparing the intermediate product for heat-sealing according to the method of FIG. 1;

FIG. 9 is a front schematic view showing a step of heat sealing the intermediate product;

FIG. 10 is a partially exploded top plan view of the heat-sealed product, illustrating a step of cutting individual patches according to the method of FIG. 1;

FIG. 11A is a perspective view of a patch thereof, shown in use adhered to headwear;

FIG. 11B is a perspective view of a patch thereof, shown adhered to a garment;

FIG. 12 is a flowchart of a method of preparing a laser-etched leather base according to an embodiment of the present invention; and

FIG. 13 is a flowchart of a method of heat-sealing embroidered leather patches to a display article according to an embodiment of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, one embodiment of the present invention is a multi-color embroidered leather article to display graphics or logos on headwear and apparel for promotional or decorative use. The present invention also provides a method for production of embroidered leather.

Embroidery allows cost-effective production of full color, detailed graphics on leather. The leather may be embroidered by machine, reducing labor and time consumed in production. In turn, the inventive method reduces costs. Moreover, the inventive embroidered leather patches are not limited to a single color. These advantages allow production of a wider array of graphics and result in a product that is cheaper to the consumer than currently available methods.

In some embodiments, the embroidered leather may be cut to a predetermined size and shape for use as a patch.

In some embodiments, the leather substrate may be pressed at a suitable temperature, such as about 320° F. to about 345° F. and heat-seal backing may be applied to the underside of the pressed leather substrate by pressing for a suitable amount of time, such as about 10 to 15 seconds. The embroidered leather piece may then be adhered to another object, such as a cap, with the heat seal. In other embodiments, heat seal may be omitted. For example, heat seal is not added to a patch that is intended as a keychain.

In some embodiments, the leather substrate may be pressed, and heat seal may be cut to size, prior to embroidering the leather.

In some embodiments, the embroidery may be performed by machine. An embroidery machine is generally operated with software that uses a digitized file of the predetermined design, graphic, or logo. Therefore, the graphic may be digitized prior to production. In some cases, the graphic may be duplicated to fit a predetermined area, resulting in an additional digital file.

A method of making an article comprising a multi-color leather patch may comprise the following steps. The user may digitize the image and may copy the image onto a predetermined number of rows and columns, saving the resulting file. The user may place the leather substrate on tear-away backing and assemble an embroidery hoop on the leather substrate and backing. The hoop, predetermined colors of thread, and the digitized file may be loaded into an embroidery machine. The machine may be activated to embroider the leather substrate. The hoop and leather may be removed from the machine and the backing may be torn away from the embroidered leather. Loose threads may be clipped away. For a keychain, the user may cut the embroidered leather into a predetermined shape and size, punch a hole into (or pierce) the leather substrate, and install a metal keyring. For headwear, horsewear, or other apparel, the user may apply a layer of heat seal onto the embroidered leather on a surface opposite the finish side and may heat seal the layers, for example at about 320° F. for about 10 seconds. After the sealed article has cooled, the user may remove a paper backing from the heat seal layer. The embroidered leather may be cut to a predetermined shape or shapes. To apply the embroidered leather to headwear, the headwear may be loaded onto a cap press with the embroidered leather article placed in a predetermined position, with the heat seal layer against the headwear. The embroidered leather article may be pressed onto the headwear, for example, at medium-high temperature twice for about 15 seconds. To apply the embroidered leather article to another substrate, the embroidered leather article may be placed in a predetermined position on the substrate and pressed at about 345° F., at medium-high pressure, e.g., twice for about 15 seconds.

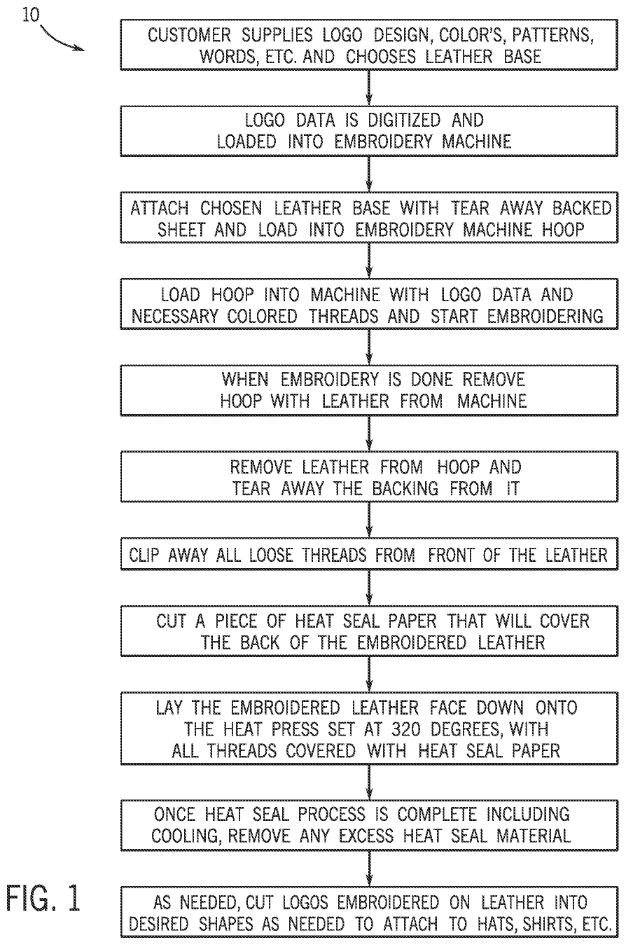

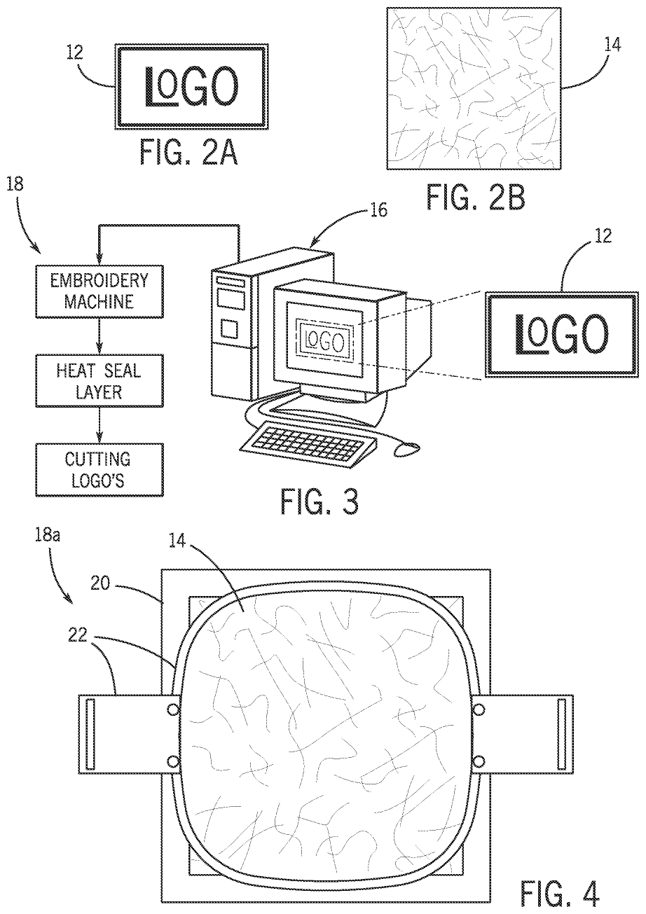

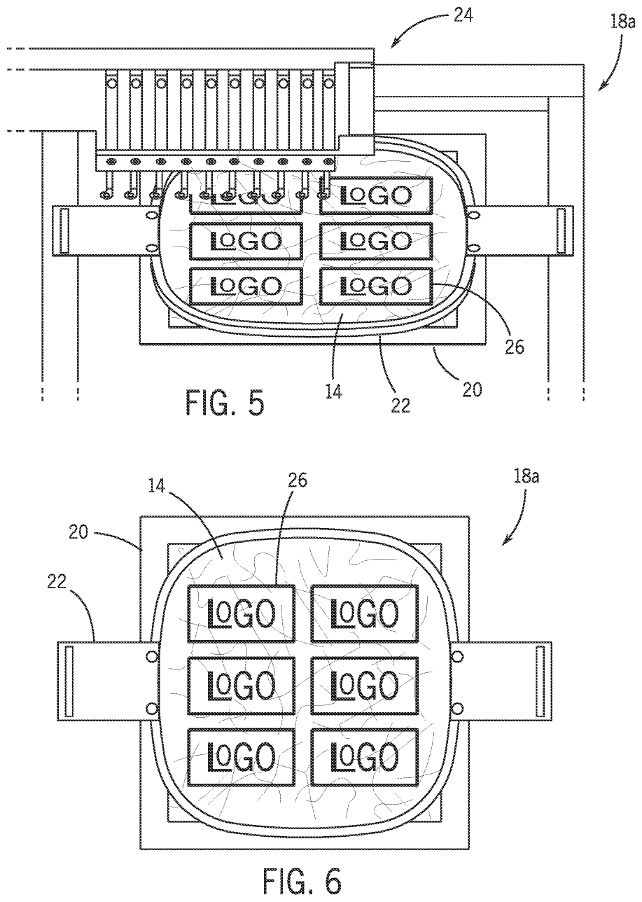

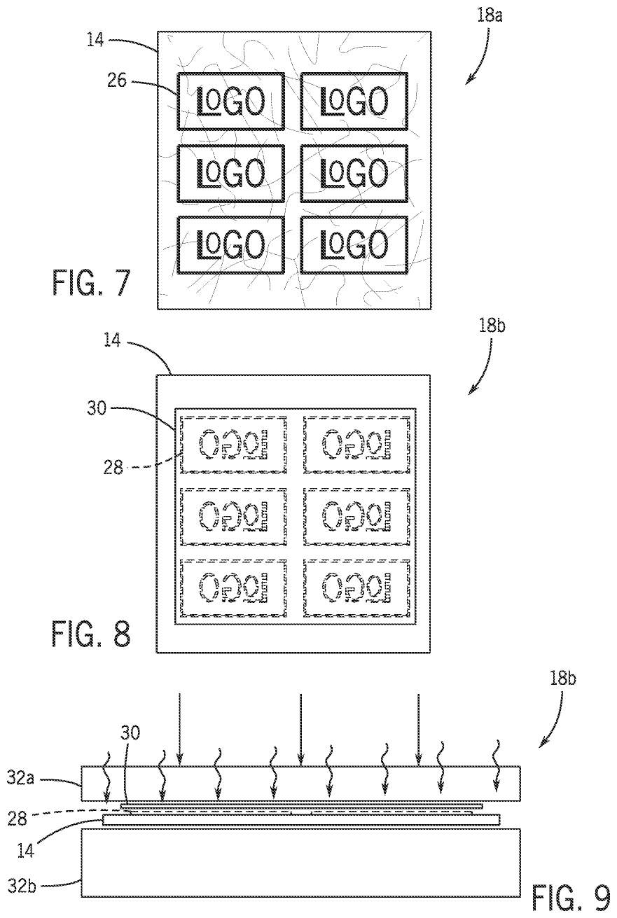

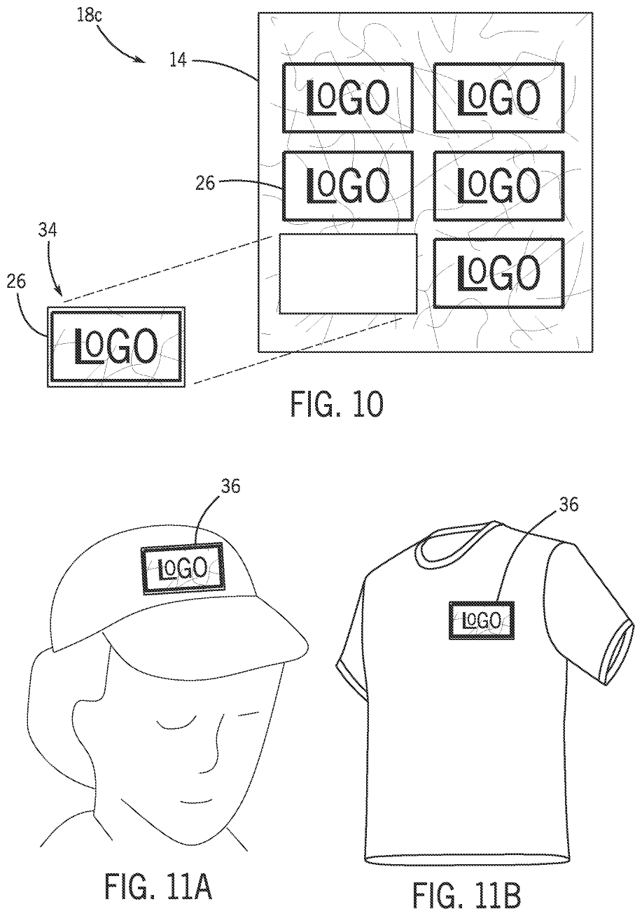

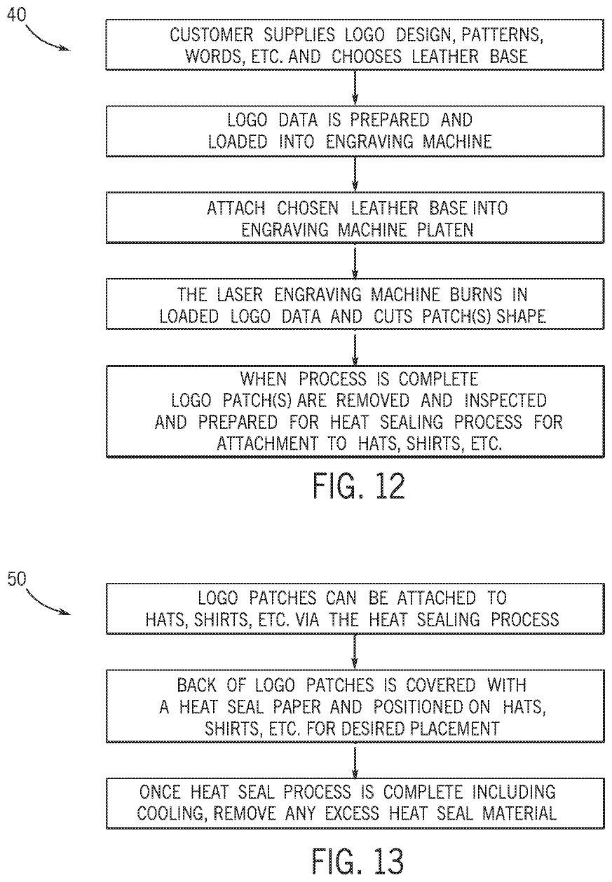

Referring to FIGS. 1 through 13, FIG. 1 shows a flowchart of a manufacturing process 10 according to an embodiment of the present invention, comprising embroidering leather and heat sealing the embroidered leather to an article, as discussed in more detail above. FIG. 2A illustrates an exemplary logo 12 and FIG. 2B illustrates a leather base 14 on which the logo 12 may be applied. As shown in FIG. 3, the logo 12 may be loaded onto an embroidery interface system 16 that may be used in a number of processes 18, including an embroidery process 18a, a heat-sealing process 18b, and a cutting process 18c. The embroidering process 18a is illustrated in FIGS. 4 through 7, wherein the leather base 14 and a tear-away backing sheet 20 are layered and secured with an embroidery hoop 22. The embroidery hoop 22 is inserted into an embroidery machine 24, as shown in FIG. 5. The resulting embroidered logos 26 are illustrated in FIG. 6. Once the embroidery hoop 22 is removed and the backing sheet 20 is pulled away, an intermediate product shown in FIG. 7 may be produced. The heat-sealing process is illustrated in FIGS. 8-9. A heat-sealing medium sheet 30 may be attached over the threads 28 on a bottom-side of the embroidered leather as shown in FIG. 8 and heat-pressed between a top heat-sealing platen 32a and a bottom heat-sealing platen 32b as shown in FIG. 9. The cutting process 18c is shown in FIG. 10. A single unit logo 34 may be cut from the sheet shown in FIG. 9 and attached to an article 36, as shown in FIGS. 11A and 11B according to a process 50 illustrated in FIG. 13. In some embodiments, embroidery may be added to a laser-etched leather base. The process of laser etching or engraving is outlined in the flowchart 40 shown in FIG. 12.

It should be understood, of course, that the foregoing relates to exemplary embodiments of the invention and that modifications may be made without departing from the spirit and scope of the invention as set forth in the following claims.

What is claimed is:

1. A multi-color embroidered leather article, comprising: a leather substrate having a finish surface and a reverse surface; and embroidery floss embroidered onto the finish surface.

2. The multi-color embroidered leather article of claim 1, wherein the finish surface is laser engraved.

3. The multi-color embroidered leather article of claim 1, further comprising a heat-seal backing adhered to the reverse surface wherein the multi-color embroidered leather article is a patch adhered to a display article.

4. The multi-color embroidered leather article of claim 1, wherein the multi-color embroidered leather article is a keychain.

5. A multi-color leather embroidery method, comprising:
a) placing a leather substrate having a finish surface and a reverse surface on a backing, with the reverse surface in direct contact with the backing;
b) assembling an embroidery hoop on the leather substrate and the backing;
c) embroidering the leather substrate and the backing;
d) removing the embroidery hoop; removing the backing; and
e) clipping excess embroidery floss from the reverse surface to produce an embroidered leather substrate.

6. The multi-color leather embroidery method of claim 5, further comprising laser engraving the leather substrate before assembling the embroidery hoop.

7. The multi-color leather embroidery method of claim 5, further comprising cutting the embroidered leather substrate into a predetermined shape and size.

8. The multi-color leather embroidery method of claim 7, further comprising:
a) piercing the leather substrate; and
b) installing a keyring.

9. The multi-color leather embroidery method of claim 5, further comprising pressing the leather substrate at a temperature of about 320° F. to about 345° F.

10. The multi-color leather embroidery method of claim 9, further comprising applying heat seal layer with a paper backing to the reverse surface; pressing the leather substrate for about 10 to 15 seconds; cooling the pressed leather substrate; and removing the paper backing from the heat seal layer.

11. The multi-color leather embroidery method of claim 10, further comprising heat sealing the heat seal layer to a display article.
